(19) United States
(12) Patent Application Publication
(10) Pub. No.: US 2002/0043627 A1
(43) Pub. Date: Apr. 18, 2002

(54) X-ray luminescent article offering improved film sharpness

(75) Inventor: Rudy Van Den Bergh, Lint (BE)

Correspondence Address: Breiner & Breiner, L.L.C., P.O. Box 19290, Alexandria, VA, 22320-0290, US

(73) Assignee: Agfa-Gevaert, Mortsel (BE)

(21) Appl. No.: 09/950,778

(22) Filed: Sep. 13, 2001

Related U.S. Application Data
(63) Continuation-in-part of application No. 09/313,188, filed on May 18, 1999, now abandoned.
(60) Provisional application No. 60/095,475, filed on Aug. 5, 1998.

(30) Foreign Application Priority Data
Jun. 26, 1998 (EP) 98202151.1

(51) Int. Cl. F21K 2/00

(52) U.S. Cl. 250/462.1

(57) ABSTRACT

In accordance with the present invention a luminescent article is provided, which luminescent article comprises a self-supporting or supported layer of phosphor particles dispersed in a binding medium and, adjacent thereto, a protective coating characterized in that, besides a binder, the said protective coating comprises as a white pigment titanium dioxide, which is present in the said binder, preferably further comprising an urethane acrylate, and wherein said protective coating has a surface roughness (Rz) between 2 and 10 μm.

This application claims priority of U.S. Provisional Application Ser. No. 60/095,475 filed Aug. 5, 1998 and is a continuation-in-part of U.S. Ser. No. 09/313,188 filed May 18, 1999.

### FIELD OF THE INVENTION.

The present invention relates to radiation-sensitive luminescent articles offering improved sharpness without loss in speed or increase of visual screen structure noise of diagnostic film images after processing.

### BACKGROUND OF THE INVENTION

In radiography the interior of objects is reproduced by means of penetrating radiation which is high energy radiation belonging to the class of X-rays, γ-rays and high energy elementary particle radiation, e.g. β-rays, electron beam or neutron radiation. For the conversion of penetrating radiation into visible light and/or ultra-violet radiation luminescent substances are used called phosphors.

In a conventional radiographic system an X-ray radiograph is obtained by X-rays transmitted imagewise through an object and converted into light of corresponding intensity in a so-called intensifying screen (X-ray conversion screen) wherein phosphor particles absorb the transmitted X-rays and convert them into visible light and/or ultraviolet radiation whereto a photographic film is more sensitive than to the direct impact of the X-rays.

In practice the light emitted imagewise by said screen irradiates a contacting light-sensitive silver halide photographic emulsion layer which, after exposure, is developed to form therein a silver image in conformity with the X-ray image.

For use in common medical radiography the X-ray film comprises a transparent film support double-side coated with a silver halide emulsion layer. During the X-ray irradiation said film is arranged in a cassette between two X-ray conversion screens each of them making contact with their corresponding silver halide emulsion layer.

Single side coated silver halide emulsion films combined in contact with only one screen are often used in autoradiography, in applications where improved image definition is of great importance e.g. in mammography and in particular fields of non-destructive testing (NDT) known as industrial radiography. An autoradiograph is a photographic record formed through the intermediary of penetrating radiation emitted by radioactive material contained in an object, e.g. microtome cut for biochemical research.

Phosphors suitable for use in the conventional radiographic system must have a high prompt emission on X-ray irradiation and low afterglow in favour of image-sharpness. It is clear that said plates or panels carrying the phosphors serve only as intermediate imaging elements and do not form the final record and that the final image is made or reproduced on a separate recording medium or display as radiographic film materials. The phosphor plates or sheets can thus be repeatedly re-used and the expected life of the plate is limited mainly by mechanical damage such as scratches.

X-ray conversion screens generally comprise in order: a support, a layer comprising phosphor particles dispersed in a suitable binder and a protective coating coated over the phosphor containing layer in order to protect said layer during use.

Since in the above described X-ray recording systems the X-ray conversion screens are used repeatedly, it is important to provide them with an adequate topcoat for protecting the phosphor containing layer from mechanical and chemical damage. Therefore the protective layer preferably has a relief structure that reduces friction as well as the tendency to show sticking phenomena with contacting materials, thus favouring loading and unloading of a film from a cassette and reducing the building up of static electricity.

Once the cassette has been loaded the contact between the film and the conventional screens, which depends on the contact area and the distance between both the screens and the photographic film, is important in order to obtain good image quality.

The optimization of the relationship between image quality and the physical characteristics of the topcoat layer of the screens has been disclosed e.g. in EP-A 0 510 754, wherein a luminescent screen has been described having an embossed protective layer, obtained by coating a liquid radiation curable composition, providing an embossed structure to the coating by a rotary-screen printing device or a gravure roller and by curing said coating by ultraviolet or electron beam curing.

From the point of view of the phosphor layer especially an increased thickness itself can give rise to increased unsharpness of the emitted light, this being the more unfavourable if the weight ratio between the amount of phosphor particles and the amount of binder decreases for the same coating amount of said phosphor particles, also called “pigment”. Enhancing the weight ratio amount of pigment to binder in order to provide sharper images, by decreasing the amount of binder leads to unacceptable manipulation characteristics of the screen due to e.g. insufficient elasticity and brittleness of the coated phosphor layer in the screen.

Several differing ways in order to produce thin screen with high absorption, i.e. with low binder to phosphor ratio, have been proposed. The lowest binder to phosphor ratio is obtained when “single crystal” screens (i.e. screens without any binder) are used. With such screens very high resolution (i.e. image sharpness) can be obtained. Such screens can be produced, e.g., by vacuum deposition of phosphor material on a substrate. However, this production method can not be used to produce high quality screens with every arbitrary phosphor available. The mentioned production method leads to the best results when phosphor crystals with high crystal symmetry are used. Phosphor having complicated crystal structures as, e.g., alkaline earth fluoro-halides, tend to decompose (partially) under vacuum deposition and the production of screens by vacuum deposition, while using phosphors with complicated crystal structure is about impossible and leads to inferior results. This means that vacuum deposition works only well with a limited number of phosphors. Moreover vacuum deposited phosphor layers have to receive special treatments to give them good physical properties. Therefore other ways reducing the thickness of the phosphor layers in screens comprising a coated layer of phosphor particles dispersed in a binder have been disclosed. One way to get thinner coated phosphor layers without changing the coated amounts of pigment and of binder makes use of a method of compressing the coated layer containing both ingredients at a temperature not lower than the softening point or melting point of the thermoplastic elastomer as has been described in EP-A 0 393 662. By this method the void ratio becomes remarkably reduced. This procedure although yielding better image quality thus requires an additional manipulation of the screen or panel. This additional manipulation is however less desirable from an economical point of view. As an alternative in EP-A 0 647 258 a luminescent article has been provided which luminescent article comprises a self-supporting or supported layer of phosphor particles dispersed in a binding medium and a protective coating thereover characterized in that the binding medium substantially consists of one or more rubbery and/or elastomeric polymers, in that the ratio by volume of phosphor to binding medium is at least 70:30 and at most 92:8 and in that the packing ratio is less than 67%. In EP-A 0 648 254 a more detailed characterization of the said rubbery polymers has been given as e.g. those block-copolymers well-known by their trade-mark names as CARIFLEX, KRATON, SOLPRENE, TUFPRENE, EUROPRENE, BUNA BL, etc. The small amount of binding agent leading to a high packing density of the phosphors does however not result in too brittle a layer in this case and the phosphor layer should contain only a minimum amount of binder only to give structural coherence to the layer. This measure does indeed not lay burden on the “elasticity” of the screen, but although having good physical properties even with those high pigment to binder ratio, the screens are sensitive to the formation of “fixed screen noise” also called “screen structure mottle” in the phosphor layer. Moreover these rubbery binders should be dissolved in toluene or a mixture of toluene and alkanes such as hexane in order to provide optimal salvation of the binder in the coating solution, thereby providing optimal flow characteristics and drying properties of the coating solution. The use of these solvents is from the point of view of ecology not desirable and a solution therefore has been brought in U.S. Pat. No. 5,663,005, wherein a screen has been provided, comprising a self-supporting or supported layer of phosphor particles dispersed in a polymeric binder, said phosphor particles being present in said binder in a volume ratio of at least 80/20 characterized in that said polymeric binder comprises at least one polymer with a T_{g}≦0° C., has an average molecular weight (MG_{avg}) between 5000 and 10⁷, is soluble in ethylacetate for at least 5% by weight (% wt/wt) and that a self-supporting layer of said polymer comprising 82% by volume of phosphor particles and having a thickness in order to comprise 100 mg of phosphor particles per cm² has an elongation at break of at least 1%.

In a preferred embodiment said polymer is soluble in ethylacetate for at least 20% by weight (% wt/wt) and in a further preferred embodiment said binder comprises at least 60% by weight of said polymer. Particularly preferred is a polymer being at least one member selected from the group consisting of vinyl resins, polyesters and polyurethane resins.

The image quality, particularly sharpness, besides being determined mainly by the thickness of the phosphor layer and the packing density as already discussed hereinbefore further especially depends on optical scattering phenomena in the phosphor layer. Those scattering phenomena particularly depend on the crystal size distribution of the phosphor particles, their morphology and the choice and amount of binder present in the phosphor layer or layers, which again is decisive for the packing density attainable for the phosphor particles. As is further also well-known the sensitivity of the screen is determined by the chemical composition of the phosphor, its crystal structure and crystal size properties, the weight amount of phoshor coated in the phosphor layer and the thickness of the phosphor layer.

It is general knowledge that sharper images with less noise are obtained with phosphor particles of smaller mean particle size, but light emission efficiency declines with decreasing particle size. Thus, the optimum mean particle size for a given application is a compromise between imaging speed and image sharpness desired.

Last but not least the wavelength of the light emitted by the intensifying screen is decisive for the sharpness obtainable with such screens: light having shorter wavelengths as the one emitted by blue and ultraviolet light emitting phosphors clearly leads to a better sharpness than light emitted from green-light emitting phosphors for images observed after processing of the radiographic films held in contact with the screens during X-ray irradiation and conversion illumination. Apart therefrom scattering of fluorescent radiation generated by the screens is known to be decreased by incorporating filter or antihalation dyes in the screens and/or in the silver halide film materials, thereby also compensating lack of resolving power of the light-sensitive silver halide emulsion layers as has been disclosed in U.S. Pat. Nos. 3,809,906; 3,872,309; 4,130,428 and 4,130,429. Any further improvement with respect to image definition, preferably without loss in speed, is thus highly appreciated.

In U.S. Pat. No. 6,188,073 manufacturing of a radiographic intensifying screen has been disclosed, said screen comprising a support, a phosphor layer and a surface protective layer overlaid in this order, the surface protective layer having a thickness of 2 to 12 μm, and more preferably of 3 to 9 μm, further characterized by incorporation in said surface protective layer of particular light-scattering fine particles comprising at least one material selected from the group consisting of zinc oxide, zinc sulfide, titanium dioxide (particularly, anatase type titanium dioxide), and lead carbonate, said particles having an average grain size of 0.1 to 1 μm. Therein it was envisaged to give the surface of the panel enough durability to resist the stains and abrasions. As set forth in Example 11 of the U.S. Pat. No. 6,188,073 atase type titanium dioxide was added into melted polyethylene terephthalate resin in an amount of 3.5 wt. % (per PET resin) in order to prepare a thin protective coating having a thickness of 6.0 μm containing said titanium dioxide. Thinning of the protective film is indeed desired for sharpness of the resultant image after processing, but a problem may arise from the presence of white particles in that this may cause visualization of so-called “screen structure noise” in the image resulting therefrom, thus disturbing said image and decreasing its diagnostic value.

### OBJECTS OF THE INVENTION

It is an object of the present invention to provide a luminescent article, e.g. in the form of a plate, panel or web, comprising a phosphor-binder layer and a protective coating applied thereto wherein said article has an excellent image resolution without loss in speed.

It is another object to offer screens that have a low manufacturing cost and high diagnostic value, i.e. without disturbing visualization of “screen structure noise”.

Other objects and advantages of the invention will become clear from the following description and examples.

### SUMMARY OF THE INVENTION.

In accordance with the present invention a luminescent article is provided which luminescent article comprises a self-supporting or supported layer of phosphor particles dispersed in a binding medium and, adjacent thereto, a protective coating characterized in that, besides a binder, the said protective coating comprises titanium dioxide as a white pigment acrylate, and in that said protective coating has a surface roughness (Rz) between 2 and 10 μm.

When said titanium dioxide white pigment is present in the said binder, preferably comprising an urethane acrylate, an improvement in sharpness of images is obtained after processing of light-sensitive silver halide photographic film materials held in contact with the said article during X-ray irradiation and subsequent conversion illumination. When said pigment is present in an amount by weight of up to 5%, more preferably up to 2% and still more preferably up to 1% versus said binder, no loss in speed for said processed film material is observed.

In order to fully reach the objects of the present invention with respect to diagnostic value of the image obtained however, said protective coating should have a surface roughness (Rz) between 2 and 10 μm, and even more preferred between 3 and 8 μm.

### DETAILED DESCRIPTION OF THE INVENTION

According to the present invention a luminescent article has thus been obtained comprising a self-supporting or supported layer of phosphor particles dispersed in a binding medium and, adjacent thereto, a protective coating characterized in that the protective coating, besides a binder, comprises titanium dioxide as a white pigment, particularly in order to obtain an improved sharpness. Said white pigment present in the protective overcoat layer is thus composed of titanium dioxide (rutile or anatase type titanium dioxide). Besides as a white pigment a luminescent phosphor can be used. Said white pigment preferably has an average particle size diameter of less than 2 μm more preferably less than 1 μm and still more preferably from 0.1-0.5 μm.

In the protective overcoat layer of the luminescent article according to present invention said white pigment is present in an amount by weight of up to 2% versus the said binder and even more preferred in an amount by weight of up to 1% versus the said binder.

Useful radiation curable compositions for forming a protective coating of the luminescent article according to the present invention contain as primary components :

(1) a crosslinkable prepolymer or oligomer,

(2) a reactive diluent monomer, and in the case of an UV curable formulation

(3) a photoinitiator.

Examples of suitable prepolymers for use in a radiation-curable composition applied according to the present invention are the following: unsaturated polyesters, e.g. polyester acrylates; urethane modified unsaturated polyesters, e.g. urethane-polyester acrylates. Liquid polyesters having an acrylic group as a terminal group, e.g. saturated copolyesters which have been provided with acryltype end groups are described in EP-A 0 207 257 and Radiat. Phys. Chem., Vol. 33, No. 5, p. 443-450 (1989). The latter liquid co-polyesters are substantially free from low molecular weight, unsaturated monomers and other volatile substances and are of very low toxicity (ref. the journal “Adhasion” 1990 Heft 12, page 12). In DE-A 2838691 the pre-paration of a large variety of radiation-curable acrylic polyesters is given. Mixtures of two or more of said prepolymers may be used. A survey of UV-curable coating compositions is given e.g. in the journal “Coating” 9/88, p. 348-353.

When the radiation-curing is carried out with ultraviolet radiation (UV), a photoinitiator is present in the coating Acomposition to serve as a catalyst to initiate the polymerization of the monomers and their optional cross-linking with the pre-polymers resulting in curing of the coated protective layer composition. A photosensitizer for accelerating the effect of the photoinitiator may be present. Photoinitiators suitable for use in UV-curable coating compositions belong to the class of organic carbonyl compounds, for example, benzoin ether series compounds such as benzoin isopropyl, isobutylether; benzil ketal series compounds; ketoxime esters; benzophenone series compounds such as benzophenone, o-benzoylmethyl-benzoate; acetophenone series compounds such as acetophenone, trichloroacetophenone, 1,1-dichloroacetophenone, 2,2-25 diethoxyaceto-phenone, 2,2-dimethoxy-2-phenylacetophenone; thioxanthone series compounds such as 2-chlorothioxanthone, 2-ethylthioxanthone; and compounds such as 2-hydroxy-2-methylpropiophenone, 2-hydroxy-4′-isopropyl-2-methylpropiophenone, 1-hydroxycyclohexylphenylketone; etc.

A particularly preferred photoinitiator is 2-hydroxy-2-methyl-1-phenyl-propan-l-one which product is marketed by E. Merck, Darmstadt, Germany under the tradename DAROCUR 1173. The above mentioned photopolymerization initiators may be used alone or as a mixture of two or more. Examples of suitable photosensitizers are particular aromatic amino compounds as described e.g. in GB-A's 1,314,556 and 1,486,911 and in U.S. Pat. No. 4,255,513 and merocyanine and carbostyryl compounds as described in U.S. Pat. No. 4,282,309.

In a particular embodiment the binder of the said protective overcoat layer in the luminescent article according to the present invention comprises a urethane acrylate. A coating dispersion is is prepared therefore, composed of a urethane acrylate oligomer and an acrylate oligomer, which both, together, form the binder of the aid protective layer and which are present in a ratio by weight of at least 2:1, more preferably about 7:3 and which together represent at least 80%, and even up to 90% by weight of the total amount of the protective layer. Well-known urethane acrylate and acrylate oligomers are GENOMEER T1600, trade name product from RAHN, Switzerland, and SERVOCURE RTT190, trade name product available from SERVO DELDEN BY, The Netherlands. A flow modifying agent, a surfactant and a photo initiator are further added, together with the white pigment, the presence of which is essential in order to reach the objects of the present invention. A more detailed description about the composition of the said protective overcoat layer can be found in the Examples hereinafter.

The roughness of the topcoat layer of the intensifying screens or luminescent articles according to the present invention offers the advantage that sticking phenomena between a film and an intensifying screen(s) in a cassette are substantially avoided even after intimate contact due to pressure build-up in the cassette system.

Correlating features of roughness and thickness of the protective coating conferring to the screens of the present invention desirable and unexpected properties of ease of manipulation and excellent image sharpness have been described in the EP-A 0 510 754.

With respect to transport characteristics of a film in a cassette the use of an X-ray conversion phosphor screen having a topcoat with embossed structure favours its practically frictionless loading and unloading of a cassette and reduces considerably the charging by static electricity. The micro-channels formed by the embossed structure of the protective coating allow air to escape between phosphor screen and contacting film whereby image quality (image sharpness) is improved by better screen-film-screen contact without large air bubble inclusions.

In a preferred embodiment the protective coating composition of the luminescent article according to the present invention is applied by screen-printing (silk-screen printing), and in a more preferred embodiment it is applied by a rotary screen printing device. An average thickness of about 10μm is measured for a commonly used protective coating of the luminescent screens.

To the radiation-curable coating composition there may be added a storage stabilizer, a colorant, and other additives. These additives may be dissolved or dispersed therein in order to prepare the coating liquid for the protective layer. Examples of colorants that can be used in the protective layer include MAKROLEX ROT EG, MAKROLEX ROT GS and MAKROLEX ROT E2G. MAKROLEX is a registered tradename of Bayer AG, Leverkusen, Germany.

When using ultraviolet radiation as curing source the photoinitiator which needs to be added to the coating solution will to a more or less extent also absorb the light emitted by the phosphor thereby impairing the sensitivity of the radiographic screen, particularly when a phosphor emitting UV or blue light is used. In case of use of a green emitting phosphor a photoinitiator has to be chosen of which the absorption range overlaps to a minimum degree with the emission range of the phosphor; a preferred photoinitiator is then DAROCUR 1173 (tradename), already mentioned hereinbefore.

The protective coating of the present luminescent article is given an embossed structure following the coating stage by passing the uncured or slightly cured coating through the nip of pressure rollers wherein the roller contacting said coating has a micro-relief structure, e.g. giving the coating an embossed structure so as to obtain relief parts. A suitable process for forming a textured structure in a plastic coating by means of engraved chill roll is described in U.S. Pat. No. 3,959,546.

According to another embodiment the textured or embossed structure is obtained already in the coating stage by applying the paste-like coating composition with a gravure roller or screen printing device operating with a radiation-curable liquid coating composition the Hoeppler-viscosity of which at a coating temperature of 25° C. is between 450 and 20,000 mPa.s.

In order to avoid flattening of the embossed structure under the influence of gravitation, viscosity and surface shear the radiation-curing is effected immediately or almost immediately after the application of the liquid coating. The rheologic behaviour or flow characteristics of the radiation-curable coating composition can be controlled by means of so-called flowing agents. For that purpose alkylacrylate ester copolymers containing lower alkyl (C1-C2) and higher alkyl (C6-C18) ester groups can be used as shear controlling agents lowering the viscosity. The addition of pigments such as colloidal silica raises the viscosity.

According to the present invention the protective coating of the luminescent article has a surface roughness (Rz) between 2 and 10 μm, and more preferably between 3 and 8 μm A surface roughness of 1 μm may provide a screen surface that is too smooth, so that “vacuum sticking” may occur yet.

Whereas the thickness of the protective layer can be measured from microscopic intersections or with a thickness measuring apparatus on microscale, roughness Rz has to be determined as the arithmetic average roughness depth value Rt of five different, but subsequent measuring area, wherein said value Rt is defined as the difference in height between the highest “top” and the lowest “valley”. A suitable instrument for such microscopically fine measurements is a “perthometer”, by means of which the surface texture can be measured according to ANSI B46.1-1985 as published by The American Society of Mechanical Engineers.

A variety of other optional compounds can be included in the radiation-curable coating composition of the present radiographic article such as compounds suitable to reduce static electrical charge accumulation, plasticizers, matting agents, lubricants, defoamers and the like as has been described in EP-A 0 510 753. In said document a description has also been given of the apparatus and methods for curing, as well as a non-limitative survey of X-ray conversion screen phosphors, of photostimulable phosphors and of binders of the phosphor containing layer.

The edges of the screen, being especially vulnerable by multiple manipulation, may be reinforced by covering the edges (side surfaces) with a polymer material being formed essentially from a moisture-hardened polymer composition prepared according to EP-A 0 541 146 by a process comprising the steps of :

(A) 30 to 99 parts by weight of at least one copolymer of olefinically unsaturated compounds having a weight-average molecular weight [Mw] of at least 1500 and containing chemically incorporated moieties capable of undergoing an addition reaction with amino groups, and

(B) 1 to 70 parts by weight of organic substances containing blocked amino groups from which substances under the influence of moisture compounds having free primary and/or secondary amino groups are formed, wherein (i) the copolymers of component (A) contain intramolecularly bound carboxylic anhydride moieties, with the anhydride equivalent weight of the copolymers being from 393 to 9,800, and the binder composition contains from 0.25 to 10 anhydride moieties for each blocked amino group,

(ii) coating the obtained mixture onto at least one side surface (edge) of said fluorescent screen, and

(iii) allowing moisture (H₂O) to come into contact with the coated 20 mixture essentially consisting of the above defined components (A) and (B).

Support materials for radiographic screens in accordance with the present invention include cardboard, plastic films such as films of cellulose acetate, polyvinyl chloride, polyvinyl acetate, polyacrylonitrile, polystyrene, polyester, polyethylene terephthalate, polyamide, polyimide, cellulose triacetate and polycarbonate; metal sheets such as aluminum foil and aluminum alloy foil; ordinary papers; baryta paper; resin-coated papers; pigment papers containing titanium dioxide or the like; and papers sized with polyvinyl alcohol or the like. A plastic film is preferably employed as the support material.

The plastic film may contain a light-absorbing material such as carbon black, or may contain a light-reflecting material such as titanium dioxide or barium sulfate. The former is appropriate for preparing a high-resolution type radiographic screen, while the latter is appropriate for preparing a high-sensitivity type radiographic screen.

Examples of preferred supports include polyethylene terephthalate, clear or blue colored or black colored (e.g., LUMIRROR C, type X30 supplied by Toray Industries, Tokyo, Japan), polyethylene terephthalate filled with TiO₂ or with BaSO₄. Metals as e.g. aluminum, bismuth and the like may he deposited e.g. by vaporization techniques to get a polyester support having radiation-reflective properties.

These supports may have thicknesses which may differ depending on the material of the support, and may generally be between 60 and 1000 μm, more preferably between 80 and 500 μm from the standpoint of handling.

In common medical radiography the screens are fixed inside a cassette allowing the arrangement of a double-side coated silver halide emulsion film inbetween. In the radiographic exposure step one silver halide emulsion layer is exposed by the fluorescent light of a front screen (the screen most close to the X-ray source) and the other silver halide emulsion layer is exposed by the fluorescent light emitted by the back screen which is the screen struck by the X-rays that have penetrated already the photographic material.

Front and back screen may be asymmetrical in that e.g. their sensitometric properties, thickness, phosphor coverage and phosphor composition may be different.

Normally the screens described hereinbefore are applied for medical X-ray diagnostic applications but according to a particular embodiment the present radiographic screens may be used in non-destructive testing (NDT), of metal objects, where more energetic X-rays and γrays are used than in medical X-ray applications. In screens applied for industrial radiography it has been found advantageous to combine the fluorescent phosphor layer with a metal layer or metal support, wherein the metal has an atomic number in the range of 46 to 83 as described e.g. in U.S. Pat. Nos. 3,872,309 and 3,389,255. The metal layer in contact with the phosphor-containing layer acts as an emitter of photo-electrons and secondary X-rays when struck by highly energetic X-rays or gamma rays. The secondary lower energy X-rays and photo-electrons are absorbed in the adjacent phosphor-containing layer at a higher efficiency than the highly energetic X-rays and gamma rays emitted by an industrial X-ray apparatus, such results in an increase in photographic speed. Said metal layers or supports have the additional advantage of reducing the scattered radiation whereby image-sharpness is improved.

According to a particular embodiment described in Research Disclosure September 1979, item 18502 image-sharpness is improved by incorporating in the X-ray intensifying screen between the phosphor-containing layer and the support and/or at the rear side of the support a pigment-binder layer containing a non-fluorescent pigment being a metal compound, e.g. salt or oxide, of a heavy metal whose atomic number (Z) is at least 46. A preferred pigment used for that purpose is lead oxide (PbO) being applied e.g. at a coverage of 100 to 400 g of lead per m².

According to the present invention said luminescent article has phosphor particles having a composition selected from the group consisting of Gd₂O₂S.Tb; YTaO₄.Nb; BaFBr.Eu and CaWO₄. It is thus clear that the choice of the phosphor or phosphor mixture is not limited to the UV or blue emitting phosphors, but that also green emitting phosphors as e.g. Gd₂O₂S:Tb can be used. The invention is even useful when prompt emitting phosphors emitting red light are used as especially in this case the problem of sharpness or definition becomes more and more stringent as radiation having a longer wavelength may lead to more lack of sharpness due to scattering which is more expressed for green and red light than for blue light. It is also clear that when screens comprising green or red emitting phosphors are used it is advantageous to combine these screens with light-sensitive silver halide film materials spectrally sensitized to the wavelength range of conversion illumination light emitted by the screen with which they are combined. Although it is well-known that silver halide crystals are sensitive in the ultra-violet and blue region of the wavelength spectrum and that this sensitivity is shifted more bathochromically when halide compositions are varying from chloride to bromide and to iodide it is clear that even spectral sensitzation in the blue region of the wavelength spectrum is highly appreciated as has e.g. been illustrated in EP-A's 0 467 155, 0 487 010, 0 568 686, 0 592 558, 0 614 542, and in U.S. Pat. No. 5,108,887.

With respect to sensitivity of the screen, also called speed the thickness thereof may be within the range of from 10 to 1000 μm, preferably from 50 to 500 μm and more preferably from 100 to 300 μm.

The coverage of the phosphor or phosphors present as a sole phosphor or as a mixture of phosphors whether or not differing in chemical composition and present in one or more phosphor layer(s) in a screen is preferably in the range from about 300 to 1500 g/m².

Said one or more phosphor layers may have the same or a different layer thickness and/or a different weight ratio amount of pigment to binder and/or a different phosphor particle size or particle size distribution.

Thus, the optimum mean particle size for a given application is a compromise between imaging speed and image sharpness desired. Preferred average grain sizes of the phosphor particles are in the range of 2 to 30 μm and more preferably in the range of 2 to 20 μm.

In the phosphor layer(s), any phosphor or phosphor mixture may be coated depending on the objectives that have to be attained with the manufactured intensifying phosphor screens. It is possible to mix fine grain phosphors with more coarse grain phosphors to increase the packing density.

Preferred phosphors are e.g. yttriumtantalate phosphors, the preparation of which is described in EP-A's 0 011 909 and 0 202 875 and in U.S. Pat. No. 5,064,729 or barium fluorobromide phosphors the preparation of which proceeds analogously as the preparation of barium fluorochloride phosphors described e.g. in GB-A's 1,161,871 and 1,254,271 and in U.S. Pat. No. 4,088,894.

A preferred barium fluorobromide phosphor has the following empirical formula : BaFBr:Eu_{0.05}, the preparation of said phosphor being carried out in such a way that at least part of the europium activator is in the trivalent state so that the phosphor has a high prompt emission on X-ray exposure as described e.g. in Radiology, Vol. 148, p. 833-838, September 1983.

Both cited prompt emission phosphors are emitting in the near UV and blue region of the visible spectrum, i.e. mainly in a wavelength range of 360 to 450 nm, and can thus be used in conjunction with a light-sensitive silver halide photographic film material, the silver halide of which has an inherent sensitivity in that spectrum range, e.g. a duplitized silver halide emulsion layer film of the type described in GB-A 1,477,637. Said phosphors can be coated individually into one or more phosphor layers of a luminescent screen or article in accordance with the present invention or a phosphor composition may be made of a mixture of both phosphors in a weight ratio range of 80/20 to 20/80 as described in EP-A 0 435 241. By the use of a mixture it is possible to produce X-ray conversion screens that have a higher brightness than phosphor screens containing solely the tantalate phosphor, resulting in the receipt of a lower X-ray dose for the patient in medical diagnosis. An extra improvement in image-sharpness can be realized with thermoplastic rubber binders when using said phosphor mixture because thinner phosphor layers are possible at higher phosphor to binder ratio as has been described in EP-A's 0 647 258 and 0 648 254 (and in the corresponding U.S. Pat. No. 5,569,530), wherein in the last mentioned patent especially KRATON-G rubbers from SHELL, The Netherlands, are recommended as a very unique class of rubbers designed for use without vulcanization.

It is clear that within the scope of the present invention the choice of the phosphor or phosphor mixture is not limited to the preferred phosphors cited hereinbefore.

A luminescent article or radiographic screen according to the present invention can be prepared by the following manufacturing process. The phosphor layer can be applied to the support by any coating procedure, making use of solvents for the binder of the phosphor containing layer as well as of useful dispersing agents, plasticizers, fillers and subbing or interlayer layer compositions that have been described in extenso in the EP-A 0 510 753.

In accordance with the present invention phosphor particles are mixed with dissolved rubbery and/or elastomeric polymers, in a suitable mixing ratio in order to prepare a dispersion.

According to one embodiment of the present invention the luminescent article comprises phosphor particles dispersed in a binding medium wherein said binding medium is a polymeric binder and wherein said phosphor particles are present in a volume ratio of at least 80/20.

In a more preferred embodiment the polymeric binder of the phosphor particles of the luminescent article according to the present invention

(i) comprises at least one polymer having a Tg≦0° C.

(ii) has an average molecular weight (MG_{avg}) between 5000 and 10⁷

(iii) is soluble in ethylacetate for at least 5% by weight (% wt/wt) and

(iv) a self-supporting layer of said polymer comprising 82% by volume of phosphor particles, having a thickness in order to comprise 100 mg of phosphor particles per cm² has an elongation at break of at least 1% as set forth in U.S. Pat. No. 5,663,005.

In a further preferred embodiment the polymeric binder of the phosphor layer(s) of the luminescent article according to the present invention is at least one member selected from the group consisting of vinyl resins, polyesters and polyurethane resins. A first preferred class of polymers to be used as binders are the vinyl resins. According to the Whittington's dictionary of plastics this class includes all resins and polymers made from monomers containing the vinyl group CH₂═CH—. Examples of such ethylenic monomers include acrylates, methacrylates, vinyl esters, olefins, styrenes, crotonic acid esters, itaconic acid diesters, maleic acid diesters, fumaric acid diesters, acrylamides, acryl compounds, vinyl ethers, vinyl ketones, vinyl heterocyclic compounds, glycidyl esters, unsaturated nitrites, polyfunctional monomers, and various unsaturated acids. Particular vinylpolymers are chosen as a function of the solubility criterium and elongation at break criterium herein before.

Commercially available examples of useful vinyl resins in this invention are PLEXISOL B372 (trade name), an acrylic resin supplied by ROHM GmbH,Germany ; ACRONAL 500L (copolymer of acrylic acid esters), ACRONAL 4F (poly-(n-butylacrylate)), ACRONAL 4L (poly-(n-butylacrylate)), ACRONAL 700L (co(n-butylacrylate/vinylisobutylether) and ACRONAL A150F (poly-(n-butylacrylate)) (trade names) all supplied by BASF, Germany; DURO-TAK 373-0036 (trade name), an acrylate resin supplied by National Starch & Chemical USA. The solubility in EtAc (ethylacetate) and the T are given in Table 1, immediately below.

TABLE 1

| Polymer | Solubility in EtAc* | Tg ° C. |
|---|---|---|
| PLEXISOL B372 | 30 | −23 |
| ACRONAL 500L | 40 | −40 à-50 |
| ACRONAL 4F | >98.5 | −40 |
| ACRONAL 4L | 50 | −40 |
| ACRONAL 700L | 50 | About −40 |
| ACRONAL A150F | >98.5 | −41 |
| DURO-TAK 373-0036 | >5 | <0 |

*in % wt/wt (% by weight)

A second class of useful polymers in this invention are polyesters with Tg≦0. This class comprises all polymers in which the main polymer backbones are formed by the esterification condensation of polyfunctional alcohols and acids. Particular polyesters are chosen as a function of the solubility criterium and elongation at break criterium herein before. Very useful polyesters are commercially available from Huls, Germany under trade name DYNAPOL (e.g. DYNAPOL S1420, with Tg-15° C ; from TOYOBO, Japan under trade name VYLON (e.g. VYLON 550 with Tg-10IC) ; from SHELL, UK under trade name VITEL.

A third class of useful polymers for incorporation in a binder mixture for a screen according to the present invention, are polyurethanes. This class comprises all polymers based on the reaction product of an organic isocyanate with compounds containing hydroxyl groups. Particular polyurethanes are chosen as a function of the solubility criterium and elongation at break criterium herein before. Very useful polyurethanes are commercially available from BAYER, Germany, under the trade name DESMOLAC (e.g. DESMOLAC 2100, DESMOLAC 4200, DESMOLAC 4125, non reactive linear polyurethanes).

If the above mentioned polymers have functional groups, an additional cross-linking can be performed, according to methods well known in literature (M. Ooka and H Ozawa : Progress in Organic coatings, 23 (1994) 325-338 and references therein). E.g. the hardening can proceed via di-or polyisocyanates.

In order to fine tune the properties (physical and optical) of the screens comprising a polymer according to the present invention, some polymeric additives in low amounts (i.e. in amounts of less than 40% by weight with respect to the total of polymeric substances present in the binder) can be present. Very suitable polymeric additives are e.g. DISPERSE AYD 9100, a trade name of Daniel Products Company, Jersey City, N.J. 07304, USA. This polymeric additive is a low molecular weight thermoplastic acrylic resin and is very useful to control the quality of the dispersion of the phosphor particles, binder(s) and solvent. The addition of cellulosic polymers, as, e.g., CAB-381-2, a trade name of Eastman Chemicals USA, can be used to fine tune mechanical properties of the coated and dried phosphor layer.

The coating dispersion may further contain a filler (reflecting or absorbing) or may be colored by a colorant capable of absorbing light within the spectrum emitted by the phosphor in the X-ray conversion screen or luminescent article of the present invention. Examples of colorants include Solvent Orange 71 (Diaresin Red 7), Solvent Violet 32 (Diaresin Violet A), Solvent Yellow 103 (Diaresin Yellow C) and Solvent Green 20 (all four supplied by Mitsubishi Chemical Industries, Japan), Makrolex Rot GS, Makrolex Rot EG, Makrolex Rot E2G, Helioechtgelb 4G and Helioechtgelb HRN (all five marketed by Bayer, Leverkusen, Germany), Neozaponfeuerrot G and Zaponechtbraun BE (both marketed by BASF, Ludwigshafen, W. Germany).

In the preparation of an intensifying radiographic screen as in the present invention, one or more additional layers are occasionally provided between the support and the phosphor containing layer, having subbing or interlayer layer compositions, in order to improve the bonding between the support and the phosphor layer, or to improve the sensitivity of the screen or the sharpness and resolution of an image provided thereby. For instance, a subbing layer or an adhesive layer may be provided by coating polymer material such as gelatin over the surface of the support on the phosphor layer side. A light-reflecting layer may be provided, e.g. by vacuum-depositing an aluminium layer or by coating a pigment-binder layer wherein the pigment is e.g. titanium dioxide. For the manufacture of light-absorbing layer, serving as anti-halation layer, carbon black dispersed in a binder may be used but also any known anti-halation dye. Such additional layer(s) may be coated on the support either as a backing layer or interposed between the support and the phosphor containing layer(s). Several of said additional layers may be applied in combination.

The use of polymers in the binder of a phosphor layer wherein the volume ratio of phosphor particles (PP)/binder (B) is higher as 80/20 makes it possible to manufacture screens with high elasticity, low brittleness, high sharpness, high speed and low noise. The volume ratio of PP/B is known to be independent of the densities of the phosphor particles (the pigment) and of the binder, while a PP/B ratio in weight is dependent on the densities of phosphor and binder.

When using other well-known binder polymers as disclosed e.g. in U.S. Pat. Nos. 2,502,529; 2,887,379; 3,617,285; 3,043,710; 3,300,310; 3,300,311 and 3,743,833, either alone or for more than 40%, in the binder, the pigment to binder volume ratio can not be increased to the high values as mentioned above, due mainly to physical properties, as e.g. adhesion and brittleness. For the hitherto used binder polymers, the ratio of pigment to binder was clearly limited by the lack in physical properties of the coated phosphor layers or by the presence of “screen structure mottle”.

The dispersion of phosphor(s) in the polymeric binder described above is uniformly applied to a substrate by a known coating technique, e.g. doctor blade coating, roll coating, gravure coating or wire bar coating, and dried to form a luminescent layer fluorescing by X-ray irradiation and called hereinafter fluorescent layer. As a consequence further mechanical treatments like compression to lower the void ratio is not required within the scope of the present invention.

Radiographic screens according to the present invention can also be made in the form of gradual screens, i.e. screens having a gradual intensification along their length and/or width. Graduality can be achieved by gradually increasing the thickness of the phosphor layer over the length or width of the screen or by incorporating into the protective layer or into an interlayer between the protective layer and phosphor containing layer a gradually increasing amount of dye capable of absorbing the light emitted by the phosphor.

According to another convenient technique graduality is obtained by halftone printing of a dye or ink composition absorbing the light emitted by the screen. By varying the screen dot size in the halftone print, i.e. by gradually varying the percent dot area over the length or width of the screen graduality can be obtained in any degree. The halftone printing can proceed on the phosphor containing layer which thereupon is covered with the protective coating or proceeds by applying the protective coating by halftone printing, }.g. by gravure roller or silk screen printing.

In the preparation of the phosphor screen having a primer layer between the substrate and the fluorescent layer, the primer layer is provided on the substrate beforehand, and then the phosphor dispersion is applied to the primer layer and dried to form the fluorescent layer.

After applying the coating dispersion onto the support, the coating dispersion is heated slowly to dryness in order to complete the formation of a phosphor layer. In order to remove entrapped air in the phosphor coating composition in an amount as much as possible it can be subjected to an ultrasonic treatment before coating.

After the formation of the fluorescent layer, a protective layer is generally provided on top of the fluorescent layer, said protective layer having been described in detail hereinbefore.

After the formation of the fluorescent layer, a protective layer is generally provided on top of the fluorescent layer, said protective layer having been described in detail hereinbefore. The invention is illustrated by the following examples without however limiting it thereto.

### EXAMPLES

### Example 1

### Sensitometry And Image Quality For Intensifying Screens.

1. Film

In manufacturing the radiographic light-sensitive silver halide photographic film a silver bromoiodide emulsion (2 mole % of silver iodide, 98 mole % of silver bromide) was used containing silver halide grains with an average grain size (equivalent circular diameter) of 1.25 μm and an average thickness of 0.22 μm as the one described in U.S. Pat. No. 5,595,864. The emulsion ready for coating contained per kg an amount of silver halide corresponding to 190 g of silver nitrate and 74 g of gelatin. The emulsion was spectrally sensitized by adding 660 mg of anhydro-5,5′-dichloro-3,3′-bis(n.sul-fobutyl)-9-ethyloxacarbocyanine hydroxide per mole of silver halide. As stabilizing agents the silver halide emulsion contained per kg 545 mg of 5-methyl-7-hydroxy-s-triazolo[1,5-a]pyrimidine and 6.5 mg of l-phenyl-5-mercaptotetrazole. The above emulsion was coated on both sides of a polyethylene terephthalate support, carrying on both sides a subbing layer. To each of the dried silver halide emulsion layers a protective layer was applied containing 1.1 g/m² of gelatin, hardened with formaldehyde and containing perfluorocaprylic acid as an antistatic agent. The hardening proceeded by adding 0.03 grams of formaldehyde per gram of gelatin. Each silver halide emulsion layer contained an amount of silver halide equivalent with 7 g of silver nitrate per m².

2. Luminescent Screen

The intensifying screen for use as luminescent article according to the present invention was containing Gd₂O₂S:Tb as a green emitting phosphor.

The screen was coated on a terephthalate support containing carbon black as light-absorbing material having a low percentage reflectance of 0-5%.

### Solvents Used In The Preparation Of The Screens

In the preparation of the screens following solvent mixtures were used, the composition, in % by volume, of which is given below.

Methylethylketone 48

Methoxypropanol 15

Ethylacetate 37

### Polymers Used In The Preparation Of The Screens

Following polymers were used in the preparations of the screens-PLEXISOL B732 (acrylic resin supplied by Rohm GmbH,Germany, further indicated as P1, said polymer having a Tg of OOC and being soluble for at least 5% by weight in ethylacetate) and-CELLIT (cellulose acetate butyrate, CELLIT, being the trade name from Eastman Chemicals, further indicated as P2).

### Preparation Of The Screens

The screens were coated from a coating composition comprising Gd₂O₂S:Tb phosphor. The phosphor used for these examples had a mean particle size of 5 μm. The composition was doctor blade coated onto a subbed 200 μm thick black polyethylene terephthalate support and dried. The coating composition was such that besides polymer P1 and polymer P2 as defined hereinbefore, DISPERSE AYD trade name of Daniel Products Company, Jersey City, N.J. 07304, USA, as a low molecular weight thermoplastic acrylic resin with Tg>0 was used as dispersing agent, in ratio amounts by weight of 5:1:1.

A subbing layer was prepared on basis of Vitel PE200 (trade name of SHELL, The Netherlands) and hardened with hardener DESMODUR N75 (tradename of Bayer AG, Leverkusen, Germany).

In the phosphor layer the phosphor/binder ratio by mass was 35 97/3 and the coating weight of the phosphor was 40 mg/cm².

The protective coating having a thickness of 10 μm was coated adjacent to the phosphor layer by screen printing. Its composition has been described hereinafter.

### Composition Of The Protective Coating.

Following products and amounts thereof were used in order to coat 10 m² of protective layer:

| | | |
|---|---|---|
| GENOMEER T1600 (urethane acrylate oligomer as a binder) | 70 | g |
| trade name of RAHN, Switzerland | | |
| SERVOCURE RTT190 (acrylate oligomer used as a binder) | 30 | g |
| trade name of SERVO DELDEN BV, The Netherlands | | |
| MODAFLOW (flow modifier, used as coating aid) | 3.0 | g |
| trade name of MONSANTO, Germany | | |
| ANTIMOUSSE 416 (surfactant) | 0.15 | g |
| trade name of RHONE POULENC, Germany | | |
| NUVOPOL PI3000 (photo initiator) | 5.0 | g |
| trade name of RAHN, Switzerland | | |

| | |
|---|---|
| TITAN AN2 (white pigment having TITANIUM DIOXIDE | x % |
| composition, particle size: 0.3 μm, trade name of BAYER | |
| AG, Leverkusen, Germany) | |

(said x % is given by weight versus the total amount of binder (GENOMEER and SERVOCURE) and is given in real figures in Table 1 hereinafter for the Screens Nos 1-5 used in the corresponding screen/film combinations).

3. Exposure

X-ray exposure of the luminescent article or screen in film/screen combination with the radiographic film, both described above, was performed so that the luminescent article or screen was arranged in a cassette and was held in intimate contact with a single-side coated silver halide emulsion film. The X-ray exposure proceeded with 28 kVp X-rays, normally used in mamography, with a filter of 35 mm plexi at the screen-film system and a FFA of 400 cm dlogK of 0.10. In the curve obtained the density is plotted versus the corrected logK value, wherein said value is corrected for air absorption.

4. Processing of the Exposed Material

The processing of the exposed silver halide emulsion material in contact with the screens Nos. 1 to 4, proceeded with the following developing liquid, followed by fixing and rinsing at the indicated temperature and processing time.

| The developing liquid had the following composition: | | |
|---|---|---|
| hydroquinone | 30 | g |
| 1-phenyl-3-pyrazolidine-1-one | 1.5 | g |
| acetic acid 99% | 9.5 | ml |
| potassiumsulphite | 63.7 | g |
| potassiumchloride | 0.8 | g |
| EDTA-2Na | 2.1 | g |
| potassium carbonate | 32 | g |
| potassiummetabisulfite | 9 | g |
| potassium hydroxyde | 14 | g |
| diethyleneglycol | 25 | ml |
| 6-methylbenztriazol | 0.09 | g |
| glutardialdehyd 50% | 9.5 | ml |
| 5-nitroindazole | 0.25 | g |
| demineralized water to make 1 l. | | |
| The starter solution to be added had the following composition: | | |
| acetic acid 99 % | 15.5 | ml |
| KBr | 16 | g |

demineralized water up to 100 ml

The overall developing time was 12 seconds at 37° C. in the total processing cycle of 45 seconds. Hereupon, the developed photographic strips were fixed in a conventional fixing bath comprising, ammonium thiosulfate and potassium metabisulfite, and then rinsed in water and allowed to dry. Sensitometric properties and values of speed and sharpness obtained for the film-screen combinations Nos. 1-5 are given in Table 2. This Table shows the speed values S, calculated from the sensitome-curve by means of the square law in order to determine the dose necessary to get a netto density of 1.0.

After processing the SWR values used in connection with Table 2 determined at 1, 2, 4 and 6 line pairs per mm (SWRl, SWR2, SWR4 SWR6 respectively). The determination of the SWR value for tensifying screens was performed with the same kVp after a Funk type K 01 mm Pb-8 lp/mm raster, with a FFA of 400 cm dlogK of 0.10.

As becomes clear from the data summarized in Table 2 hereinafter the presence of white pigment TiO₂ in an amount of up to 15.2% by weight versus the total amount of binder present in the protective coating adjacent to the phosphor layer leads to an oved sharpness without loss in speed.

TABLE 2

| Screen/ | TiO₂ | | | | | | |
|---|---|---|---|---|---|---|---|
| Film | (x % vs. | | | | | | |
| No. | binder) | S | SWR1 | SWR2 | SWR4 | SWR6 | σ_{d} |
| 1 | 0.00 | 0.14 | 0.91 | 0.82 | 0.61 | 0.41 | 0.0242 |
| 2 | 0.25 | 0.13 | 0.92 | 0.84 | 0.64 | 0.43 | 0.0243 |
| 3 | 0.50 | 0.12 | 0.90 | 0.82 | 0.65 | 0.44 | 0.0242 |
| 4 | 1.00 | 0.13 | 0.92 | 0.85 | 0.65 | 0.46 | 0.0244 |
| 5 | 2.00 | 0.13 | 0.93 | 0.85 | 0.63 | 0.42 | 0.0256 |

### Example 2.

Following data summarized in Table 3 are illustrative for the effect of addition of huge amounts of white pigment (same anatase type titanium dioxide pigment just as in Example 1) and the roughness of the screen at the surface. Film, screen (except for the coating weight which is 35 mg/cm² and amounts of TiO₂ (x% vs.binder, just as in Table 2), exposure and processing of film materials Nos.6-9 were the same as in Example 1.

Roughness Rz has been determined as the arithmetic average roughness depth value Rt of five different, but subsequent measuring area, wherein said value Rt is defined as the difference in height between the highest “top” and the lowest “valley”. As an instrument suitable for measuring such microscopically fine unevenness, use was made of a “perthometer”, by means of which the surface texture can be measured according to ANSI B46.1-1985 as published by The American Society of Mechanical Engineers.

In the Table 2 values of surface roughness Rz are all in the range between 4 and 5 μm.

Figures of ‘•_{d}’ given in Table 3, last column, are representative for noise, resulting from presence of white particles in the protective coating of the screen. Therefore optical densities were measured using a scanning microdensitometer (Perking-Elmer-PDS Microdensitometer). For a measuring aperture of 100 μm, illumination aperture of 150 μm and sample distance of 50 μm, •_{d} (standard deviation of optical density) was calculated at an optical density of 1.00 above minimum density, making use of 2560 data points.

Moreover values of “Visual screen noise”, as percepted by an examining medecine on the processed film, are given: figures going from “4” to “1” are indicative for an “unacceptable” to an “excellent” situation, a figure from “2” on being “good”, “3” being “acceptable”.

TABLE 3

| | TiO₂ | | | | | | Visual | |
|---|---|---|---|---|---|---|---|---|
| S/F | (x % vs. | | | | | | screen | |
| No. | binder) | S | SWR1 | SWR2 | SWR4 | SWR6 | noise | σ_{d} |
| 6 | 0.00 | 0.17 | 0.91 | 0.84 | 0.64 | 0.45 | 1 | 0.0207 |
| 7 | 5.00 | 0.17 | 0.93 | 0.87 | 0.69 | 0.47 | 2 | 0.0226 |
| 8 | 10.00 | 0.14 | 0.92 | 0.87 | 0.70 | 0.50 | 3 | 0.0239 |
| 9 | 20.00 | 0.11 | 0.92 | 0.86 | 0.68 | 0.49 | 4 | 0.0258 |

As becomes clear from the data summarized in Table 3, the presence of white pigment TiO₂ in an amount 5% by weight or more versus the total amount of binder present in the protective coating adjacent to the phosphor layer leads to an improved sharpness (see especially the effect on sharpness at higher line pairs per mm).

However a loss in speed, especially for amounts of the said white pigment versus binder of more than 5 wt %, appears. When such loss in speed and increased values of “σ_{d}” both remain acceptable (as well as is the case for the “visual screen noise”), gain in sharpness is excellent, as is the case for amounts of the said white pigment versus binder being not higher than 5%, and, more preferably, around 2-2.5% by weight as will be illustrated hereinafter.

With respect thereto coatings Nos. 10-13 were prepared as in Examples hereinbefore, with that difference that the white ment was present in an amount of 2% by weight now, and that the tective coating was provided by the screen printing method, the hod being applied in order to obtain different values of Rz, as lustrated in the Table 4 hereinafter.

TABLE 4

| | TiO₂ | | | | | | Visual | |
|---|---|---|---|---|---|---|---|---|
| S/F | (x % vs. | | | | | | screen | Rz |
| No. | binder) | S | SWR1 | SWR2 | SWR4 | SWR6 | noise | (μm) |
| 10 | 2.00 | 0.16 | 0.92 | 0.84 | 0.64 | 0.45 | 1 | 2.11 |
| 11 | 2.00 | 0.17 | 0.93 | 0.86 | 0.65 | 0.47 | 2 | 4.43 |
| 12 | 2.00 | 0.17 | 0.93 | 0.85 | 0.63 | 0.46 | 3 | 7.46 |
| 13 | 2.00 | 0.15 | 0.92 | 0.86 | 0.65 | 0.45 | 4 | 10.55 |

Symbols used in that Table 4 have the same significance as in Tables given hereinbefore. As can be concluded from the data given in the Table 4, an acceptable visual screen noise is not attainable any more from the moment that a surface roughness of more than 10 μm has been exceeded for the pigmented surface coating of screen.

The range of surface roughness as claimed, however, simultaneously provides improved image definition (sharpness) by application of a pigmented protective coating comprising titanium dioxide as a white pigment, without the disturbing disadvantage of manutention known as “vacuum sticking”, and without laying burden on the diagnostic value of the image on the processed film, due to “visual screen noise”, wherein said image has been obtained after processing of the film, having been in contact with the luminescent article according to the present invention during exposure to X-rays

In other words: it has been shown in the present invention that, although sharpness becomes better after addition of white pigment to the protective surface coating of a luminescent screen, roughening of the protective coating of said luminescent screen in order to avoid vacuum sticking in a casette does not necessarily lead to visualization of screen structures, known as “screen structure noise”. A range wherein amounts of pigment and screen roughness are chosen well, as claimed, thus provides all benifits as strived after, as has been set forth in the objects of the present invention.

Having described in detail preferred embodiments of the current invention, it will now be apparent to those skilled in the art that numerous modifications can be made therein without departing from the scope of the invention as defined in the appending claims.

1. Luminescent article comprising a self-supporting or supported layer of phosphor particles dispersed in a binding medium and, adjacent thereto, a protective coating characterized in that, besides a binder, the said protective coating comprises titanium dioxide as a white pigment and in that said protective coating has a surface roughness (Rz) between 2 and 10 μm.

2. Luminescent article according to claim 1, wherein said surface roughness (Rz) is between 3 and 8 μm.

3. Luminescent article according to claim 1, wherein said binder comprises a urethane acrylate.

4. Luminescent article according to claim 1, wherein said white pigment is present in an amount by weight of up to 5% versus said binder.

5. Luminescent article according to claim 1, wherein said white pigment is present in an amount by weight of up to 2% versus said binder.

6. Luminescent article according to claim 1, wherein said white pigment is present in an amount by weight of up to 1% versus said binder.

7. Luminescent article according to claim 1, wherein said phosphor particles are dispersed in a binding medium, being a polymeric binder, wherein said phosphor particles are present in a volume ratio of at least 80/20.

8. Luminescent article according to claim 7, wherein said polymeric binder (i) comprises at least one polymer having a T_{g}≦0° C., (ii) has an average molecular weight (MG_{avg}) between 5000 and 10⁷, (iii) is soluble in ethylacetate for at least 5% by weight.

9. Luminescent article according to claim 7, wherein said polymeric binder is at least one member selected from the group consisting of vinyl resin, polyesters and polyurethane resins.

10. Luminescent article to claim 7, wherein said phosphor particles have a composition selected from the group consisting of Gd₂O₂S:Tb; GdOBr:Tm; YTaO₄:Nb; BaFBr:Eu, BaFCl:Eu and CaWO₄.

11. Luminescent article to claim claim 1, wherein said protective coating is provided by means of screen printing.

12. Luminescent article to claim claim 2, wherein said protective coating is provided by means of screen printing.
